(19) United States
(12) Patent Application Publication
(10) Pub. No.: US 2026/0099634 A1
(43) Pub. Date: Apr. 9, 2026

(54) Systems and Methods for Enhancing Security for Multi-Tenant FPGA Operations

(71) Applicants: Archanna Srinivasan, San Jose, CA (US); Teik Wah Lim, Bayan Lepas (MY); Pravin Chander Chandran, Fremont, CA (US)

(72) Inventors: Archanna Srinivasan, San Jose, CA (US); Teik Wah Lim, Bayan Lepas (MY); Pravin Chander Chandran, Fremont, CA (US)

(21) Appl. No.: 19/416,846

(22) Filed: Dec. 11, 2025

(51) Int. Cl. G06F 21/76; G06F 1/26

(52) U.S. Cl. CPC G06F 21/76; G06F 1/263

(57) ABSTRACT

Embodiments herein are directed to systems and methods for enhancing the security of multi-tenant FPGA operations. A multi-tenant field-programmable gate array (FPGA) system may include a first fabric partition and a second fabric partition. A periphery of the second fabric partition may be programmed with barrier logic to isolate the second fabric partition from the first fabric partition.

### BACKGROUND

The present disclosure relates generally to programmable logic devices. More particular, the present disclosure relates to isolation and security in multi-tenant programmable logic devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

In certain integrated circuit systems, such as field-programmable gate array (FPGA) systems, a single FPGA may include multiple partitions of programmable logic, each partition including a “tenant.” As defined herein, a tenant may include a user or customer who is provided with a partition of the FPGA that may be used by that tenant to carry out one or more operations as desired by the tenant. In this manner, multiple users or customers may be provided with a partition of a single hardware device, which may improve resource utilization and cost efficiency. However, tenants in multi-tenant systems may wish to avoid potential side-channel attacks from neighboring tenants.

### BRIEF DESCRIPTION OF THE DRAWINGS

Various aspects of this disclosure may be better understood upon reading the following detailed description and upon reference to examples shown in the drawings in which:

FIG. 1 is a block diagram of a system used to program an integrated circuit device;

FIG. 2 is a block diagram of the integrated circuit device of FIG. 1,

FIG. 3 is a schematic diagram of a multi-tenant programmable logic device (e.g., FPGA) having a secured workload island;

FIG. 4 is a schematic diagram of a multi-tenant programmable logic device (e.g., FPGA) wherein each fabric partition includes an independent power supply;

FIG. 5 is a flowchart of a method for implementing the secure workload island discussed with respect to FIG. 3; and

FIG. 6 is a block diagram of a data processing system that incorporates the multi-tenant programmable logic device (e.g., FPGA) having the secured workload island.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure describes systems and methods related to enhancing security of a programmable fabric partition. In certain integrated circuit systems, such as field-programmable gate array (FPGA) systems, a single FPGA may include multiple partitions of programmable logic, each partition including a tenant. In this manner, multiple users or customers may be provided with a partition of a single hardware device, which may improve resource utilization and cost efficiency. However, tenants in multi-tenant systems may in some scenarios be vulnerable to side-channel attacks from neighboring tenants. To reduce or eliminate the occurrence of side-channel attacks from neighboring tenants of the FPGA or attacks from outside of the FPGA, one or more fabric partitions of the FPGA may be implemented as respective secured workload islands. To implement the one or more fabric partitions as secured workload islands, a fabric partition may be isolated from the other fabric partitions by surrounding the fabric partition with “do not use” logic to create a barrier between the programmable logic within the secured workload islands and any external logic. Additionally or alternatively, the unused logic surrounding the programmable logic may be programmed as ring oscillators. Moreover, if there are logic components within the fabric partition such as scramblers, counters, and so on as part of the core of the fabric partition, they may be placed near the periphery (e.g., near the “do not use” logic and/or the ring oscillators) to further mitigate or prevent side channel attacks. In this manner, the secured workload islands may make a tenant secure from side-channel attacks from other tenants of the FPGA.

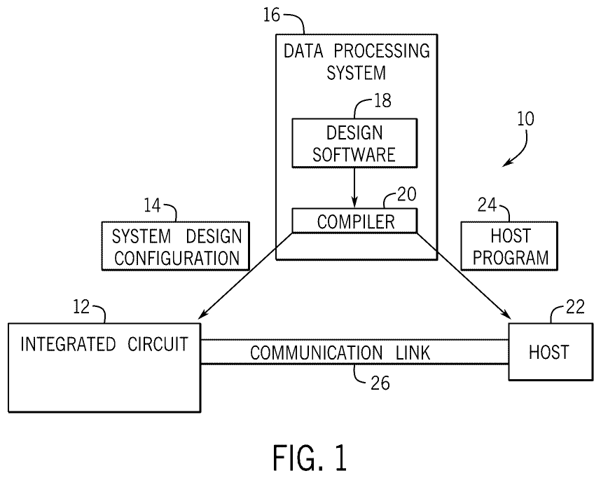

With the foregoing in mind, FIG. 1 illustrates a block diagram of a system 10 that may be used to implement the secured workload islands. The system 10 that may be used to program an integrated circuit device 12, such as an FPGA (e.g., an Agilex™, Stratix®, Arria®, MAX®, or Cyclone® device by Altera® Corporation), with such a system design using a system design configuration 14. Note that, while this disclosure largely refers to the integrated circuit device 12 as being a programmable logic device, such as an FPGA, in some embodiments, the integrated circuit device 12 may also include a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

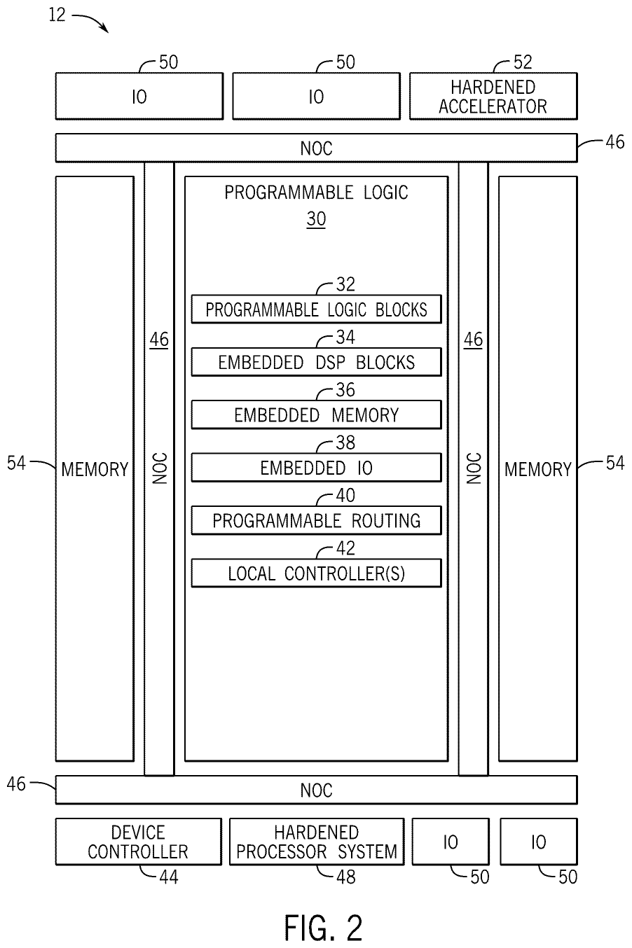

The integrated circuit device 12 may take any suitable form that may implement the system design configuration 14. In one example shown in FIG. 2, the integrated circuit device 12 may include programmable logic circuitry 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

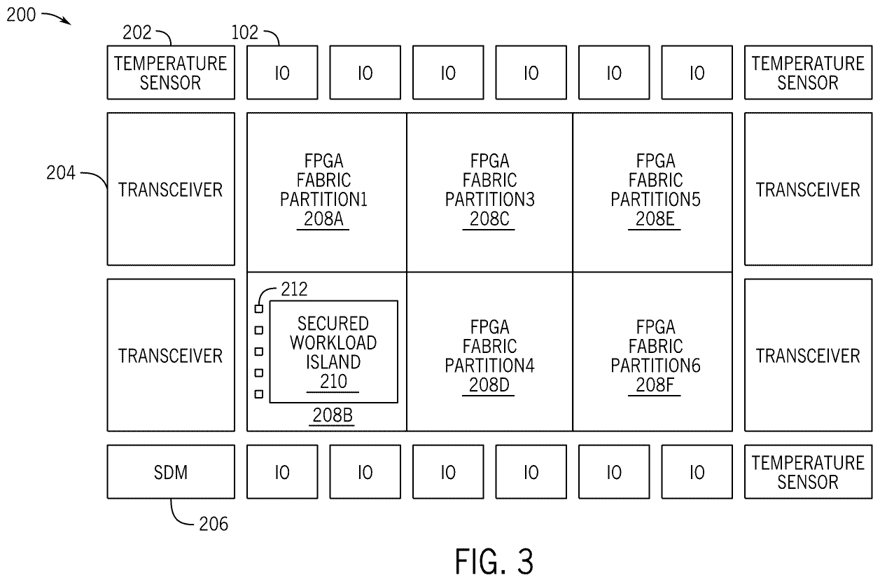

FIG. 3 is a schematic diagram of a multi-tenant programmable logic device (e.g., FPGA) having a secured workload island. A multi-tenant FPGA 200, representing one example of the integrated circuit device 12, includes components surrounding the periphery of programmable logic fabric. The components may include the input/output elements 102 (e.g., corresponding to the IO blocks 50 of FIG. 2), sensors such as temperature sensors 202, transceivers 204 (e.g., which may be components of or separate from the IO blocks 50 of FIG. 2), and a secure device manager (SDM) 206 (e.g., corresponding to the device controller 44 of FIG. 2). The multi-tenant FPGA 200 includes multiple fabric partitions 208A, 208B, 208C, 208D, 208E, and 208F (collectively, the fabric partitions 208), which correspond to partitions of the programmable logic circuitry 30 of FIG. 2. Each fabric partition may belong to a single tenant, though some tenants may occupy multiple partitions, where a tenant may include an entity (e.g., user, customer) who is provided with a partition 208 that may be used by that tenant to carry out one or more operations as desired by the tenant. In this manner, multiple users or customers may be provided with a fabric partition 208 of a single hardware device (e.g., the multi-tenant FPGA 200), which may improve resource utilization and cost efficiency. However, tenants in the multi-tenant FPGA 200 may in some scenarios be vulnerable to side-channel attacks from neighboring tenants.

To reduce or eliminate the occurrence of side-channel attacks from neighboring tenants of the multi-tenant FPGA 200 or attacks from outside of the multi-tenant FPGA 200, one or more fabric partitions 208 of the multi-tenant FPGA 200 may be implemented as respective secured workload islands. As may be observed, the fabric partition 208B is implemented with a secured workload island 210. When implemented with the secured workload island 210, the fabric partition 208B may be isolated from the other fabric partitions 208A and 208C-F by surrounding the fabric partition 208B with barrier logic 212 (e.g., “do not use” logic) to create a barrier between the programmable logic within the secured workload island 210 and any external logic or inputs/outputs from other fabric partitions 208. The “do not use” logic may represent any suitable logic circuitry that reduces the ability of a third party to observe the operation of the fabric partition 208. The “do not use” logic can be formed using programmable logic 30. In one example, the programmable logic 30 may be programmed with a simple buffer ring around the secure workload island 210. A user may configure any type of logic gates sprinkled around the workload island 210 to form the “do not use” logic. In some embodiments, the “do not use” logic may be restricted as a “do not use area” using the design software 18.

Additionally or alternatively, the barrier logic 212 surrounding the secured workload island 210 may be programmed as ring oscillators. Moreover, if there are logic components within the secured work island 210 such as scramblers, counters, and so on as part of the core of the fabric partition 208B, those logic components may be placed near the periphery of the secured workload island 210 (e.g., near the barrier logic 212) to further mitigate or prevent side channel attacks. In this manner, the secured workload islands may make a tenant secure from side-channel attacks from other tenants of the FPGA. It should be noted that while only 208B is shown to include a secured workload island 210, any other partitions 208 may include the secured workload island 210.

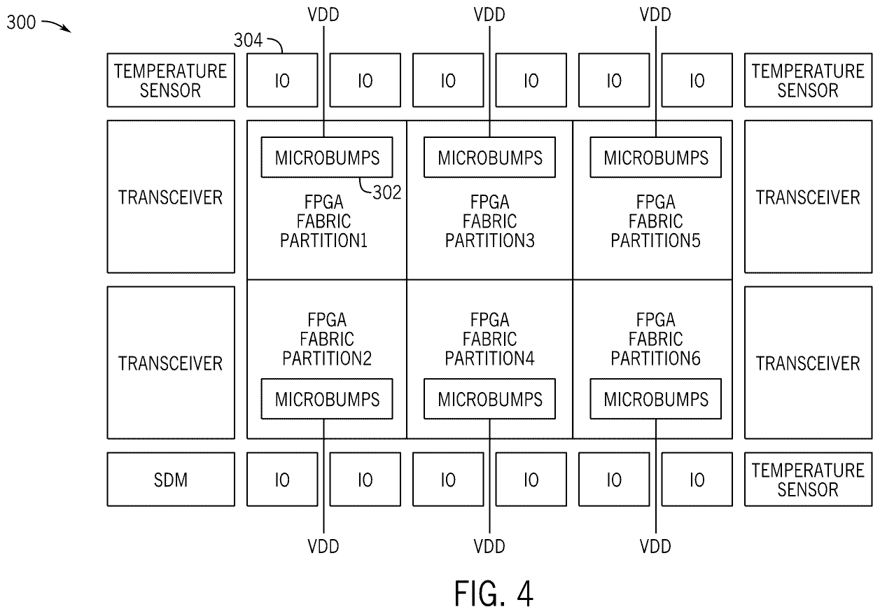

In some multi-tenant FPGA architectures, the fabric partitions 208 may share a common power supply. An additional measure to ensure isolation between the fabric partitions 208 is to separate the power sources such that each fabric partition 208 includes its own power supply. FIG. 4 illustrates a multi-tenant FPGA 300, representing another example of the integrated circuit device 12, where each fabric partition 208 includes an independent power supply (e.g., power supplies that are independently configurable from one another; power supplies that receive different supplies of off-die electrical energy; power supplies that are not otherwise connected on the same die as one another, such that monitoring one power supply may not reveal substantial information about rates of power being drawn by another power supply). The multi-tenant FPGA 300 includes the fabric partitions 208. Each fabric partition 208 includes an electrical connection, such as microbumps 302. In lieu of microbumps 302, any other suitable die-to-die connection resources may be used. Each fabric partition 208 has a respective power supply 304 that provides power to each respective fabric partition 208 via the microbumps 302. By physically separating the power supplies 304 of the fabric partitions 208, an additional layer of isolation is afforded between the fabric partitions 208, enhancing the security of each respective fabric partition 208. It should be noted that the independent power supplies described with respect to FIG. 4 and the secure workload island 210 may be used together on the same multi-tenant FPGA. That is, the structures and methods discussed with respect to FIGS. 3-4 may be combined and used together to enhance tile partition security.

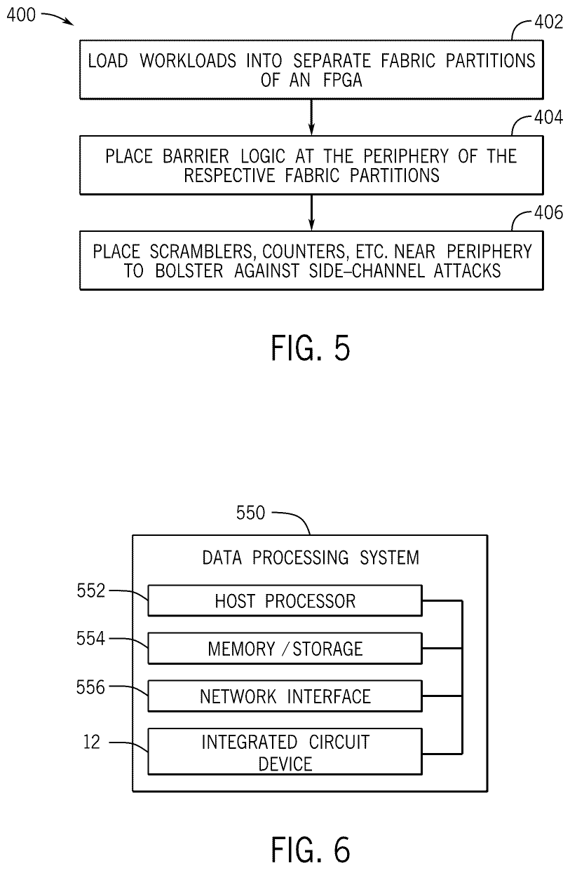

FIG. 5 is a flowchart of a method 400 for implementing the secure workload island 210 discussed with respect to FIG. 3. The steps of the method 400 may be carried out by the integrated circuit system 12 (e.g., the multi-tenant FPGAs 200 and/or 300), the compiler 16, and/or the design software 14. In process block 402, the compiler 16 may load workloads into separate fabric partitions 208 of the multi-tenant FPGAs 200 and/or 300. In process block 404, the compiler 16 may place barrier logic 212 in the periphery of the fabric partition 208. In process block 406, the compiler 16 may place scramblers, counters, etc. near periphery of the secured workload island 210 to further enhance security of the fabric partition 208. In this manner, the fabric partition 208 may benefit from enhanced security from side-channel attacks.

The processes discussed above may be carried out on the integrated circuit system 12, which may be a component included in a data processing system, such as a data processing system 550, shown in FIG. 6. The data processing system 550 may include the integrated circuit system 12 (e.g., a programmable logic device), a host processor 552, memory and/or storage circuitry 554, and a network interface 556. The data processing system 550 may include more or fewer components (e.g., electronic display, user interface structures, application specific integrated circuits (ASICs)). The host processor 552 may include any of the foregoing processors that may manage a data processing request for the data processing system 550 (e.g., to perform elaboration and simulation, to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 554 may include random access memory (RAM), read-only memory (ROM), one or more hard drives, flash memory, or the like. The memory and/or storage circuitry 554 may hold data to be processed by the data processing system 550. In some cases, the memory and/or storage circuitry 554 may also store configuration programs (e.g., bitstreams, mapping function) for programming the integrated circuit system 12. The network interface 556 may allow the data processing system 550 to communicate with other electronic devices. The data processing system 550 may include several different packages or may be contained within a single package on a single package substrate. For example, components of the data processing system 550 may be located on several different packages at one location (e.g., a data center) or multiple locations. For instance, components of the data processing system 550 may be located in separate geographic locations or areas, such as cities, states, or countries.

The data processing system 550 may be part of a data center that processes a variety of different requests. For instance, the data processing system 550 may receive a data processing request via the network interface 556 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A multi-tenant field-programmable gate array (FPGA) system comprising:
a first fabric partition; and
a second fabric partition, wherein the first fabric partition is coupled to a first independent power supply and the second fabric partition is coupled to a second independent power supply.

EXAMPLE EMBODIMENT 2. The multi-tenant FPGA system of example embodiment 1, wherein the barrier logic comprises do-not-use logic.

EXAMPLE EMBODIMENT 3. The multi-tenant FPGA system of example embodiment 1, wherein the barrier logic comprises a ring oscillator.

EXAMPLE EMBODIMENT 4. The multi-tenant FPGA system of example embodiment 1, wherein programmable logic of the second fabric partition comprises scramblers, counters, or both, wherein the scramblers, counters, or both are placed at a periphery of the first partition.

EXAMPLE EMBODIMENT 5. The multi-tenant FPGA system of example embodiment 1, wherein a periphery of the second fabric partition is programmed with barrier logic to isolate the second fabric partition from the first fabric partition.

EXAMPLE EMBODIMENT 6. The multi-tenant FPGA system of example embodiment 1, wherein the first power supply is physically separated from the second power supply.

EXAMPLE EMBODIMENT 7. The multi-tenant FPGA system of example embodiment 5, wherein the first fabric partition comprises a first set of microbumps configurable to couple to the first power supply and the second fabric partition comprises a second set of microbumps configurable to couple to the second power supply.

EXAMPLE EMBODIMENT 8. A method comprising:
loading a workload into a fabric partition of a multi-tenant field-programmable gate array (FPGA); and
loading barrier logic configured to isolate the fabric partition at a periphery of the fabric partition.

EXAMPLE EMBODIMENT 9. The method of example embodiment 8, wherein the barrier logic comprises do-not-use logic.

EXAMPLE EMBODIMENT 10. The method of example embodiment 8, wherein the barrier logic comprises a ring oscillator.

EXAMPLE EMBODIMENT 11. The method of example embodiment 8, comprising determining whether the workload of the programmable logic of the fabric partition comprises scramblers, counters, or both.

EXAMPLE EMBODIMENT 12. The method of example embodiment 11, comprising, based on determining that the workload of the programmable logic of the fabric partition comprises scramblers, counters, or both:
placing the scramblers, counters, or both at a periphery of the workload.

EXAMPLE EMBODIMENT 13. The method of example embodiment 8, comprising running design software designating the periphery of the fabric partition as a “do not use” area to restrict access to the periphery of the fabric partition to a user of the design software.

EXAMPLE EMBODIMENT 14. A device comprising:
a first fabric partition coupled to a first power supply; and
a second fabric partition coupled to a second power supply, wherein a periphery of the second fabric partition is programmed with barrier logic to isolate the second fabric partition from the first fabric partition.

EXAMPLE EMBODIMENT 15. The device of example embodiment 14, wherein the barrier logic comprises do-not-use logic.

EXAMPLE EMBODIMENT 16. The device of example embodiment 14, wherein the barrier logic comprises a ring oscillator.

EXAMPLE EMBODIMENT 17. The device of example embodiment 14, wherein programmable logic of the second fabric partition comprises scramblers, counters, or both, and the scramblers, counters, or both are placed at the periphery of the programmable logic.

EXAMPLE EMBODIMENT 18. The device of example embodiment 18, wherein the first power supply is physically separated from the second power supply.

EXAMPLE EMBODIMENT 19. The device of example embodiment 18, wherein the first fabric partition comprises a first set of microbumps configurable to couple to the first power supply.

EXAMPLE EMBODIMENT 20. The device of example embodiment 18, wherein the second fabric partition comprises a second set of microbumps configurable to couple to the second power supply.

What is claimed is:

1. A multi-tenant field-programmable gate array (FPGA) system comprising:
a first fabric partition; and
a second fabric partition, wherein the first fabric partition is coupled to a first independent power supply and the second fabric partition is coupled to a second independent power supply.

2. The multi-tenant FPGA system of claim 1, wherein the barrier logic comprises do-not-use logic.

3. The multi-tenant FPGA system of claim 1, wherein the barrier logic comprises a ring oscillator.

4. The multi-tenant FPGA system of claim 1, wherein programmable logic of the second fabric partition comprises scramblers, counters, or both, wherein the scramblers, counters, or both are placed at a periphery of the first partition.

5. The multi-tenant FPGA system of claim 1, wherein a periphery of the second fabric partition is programmed with barrier logic to isolate the second fabric partition from the first fabric partition.

6. The multi-tenant FPGA system of claim 1, wherein the first power supply is physically separated from the second power supply.

7. The multi-tenant FPGA system of claim 5, wherein the first fabric partition comprises a first set of microbumps configurable to couple to the first power supply and the second fabric partition comprises a second set of microbumps configurable to couple to the second power supply.

8. A method comprising:
loading a workload into a fabric partition of a multi-tenant field-programmable gate array (FPGA); and
loading barrier logic configured to isolate the fabric partition at a periphery of the fabric partition.

9. The method of claim 8, wherein the barrier logic comprises do-not-use logic.

10. The method of claim 8, wherein the barrier logic comprises a ring oscillator.

11. The method of claim 8, comprising determining whether the workload of the programmable logic of the fabric partition comprises scramblers, counters, or both.

12. The method of claim 11, comprising, based on determining that the workload of the programmable logic of the fabric partition comprises scramblers, counters, or both:
placing the scramblers, counters, or both at a periphery of the workload.

13. The method of claim 8, comprising running design software designating the periphery of the fabric partition as a “do not use” area to restrict access to the periphery of the fabric partition to a user of the design software.

14. A device comprising:
a first fabric partition coupled to a first power supply; and
a second fabric partition coupled to a second power supply, wherein a periphery of the second fabric partition is programmed with barrier logic to isolate the second fabric partition from the first fabric partition.

15. The device of claim 14, wherein the barrier logic comprises do-not-use logic.

16. The device of claim 14, wherein the barrier logic comprises a ring oscillator.

17. The device of claim 14, wherein programmable logic of the second fabric partition comprises scramblers, counters, or both, and the scramblers, counters, or both are placed at the periphery of the programmable logic.

18. The device of claim 14, wherein the first power supply is physically separated from the second power supply.

19. The device of claim 18, wherein the first fabric partition comprises a first set of microbumps configurable to couple to the first power supply.

20. The device of claim 18, wherein the second fabric partition comprises a second set of microbumps configurable to couple to the second power supply.
